(19) United States
(12) Patent Application Publication
(10) Pub. No.: US 2006/0224908 A1
(43) Pub. Date: Oct. 5, 2006

(54) Sharing apparatus and energy conservation controlling method therefor

(75) Inventor: Fumio Aizawa, Osaka (JP)

Correspondence Address: SMITH, GAMBRELL & RUSSELL, 1850 M STREET, N.W., SUITE 800, WASHINGTON, DC, 20036, US

(73) Assignee: Kyocera Mita Corporation

(21) Appl. No.: 11/097,209

(22) Filed: Apr. 4, 2005

(51) Int. Cl. G06F 1/32

(52) U.S. Cl. 713/320

(57) ABSTRACT

When any of a plurality of terminal devices 3 accesses an MFP 1 that is networked to the terminal devices 3, an IP address assigned to the terminal device 3 is stored in an address storage section 172 in the MFP 1. A signal is periodically transmitted to all the terminal devices 3 corresponding to the IP addresses stored in the address storage section 172 in order to judge whether or not the terminal devices 3 are accessible to the MFP 1. when it is judged that none of the terminal devices 3 corresponding to the IP addresses stored in the address storage section 172 are accessible to the MFP 1 as a result of the judgment, the state of the power to the MFP 1 is switched to a power saving state.

### BACKGROUND OF THE INVENTION

1. Field of the Invention

The present invention relates to a sharing apparatus that is networked to a plurality of terminal devices and an energy conservation controlling method therefor.

2. Description of Related Art

Generally, a sharing apparatus such as a printer is networked to a plurality of terminal devices (e.g., personal computers) so that processing based on a signal transmitted from each of the terminal devices (e.g., processing for transferring an image based on image data onto paper) can be performed. Such a sharing apparatus is accessible from all the terminal devices to which it is networked. Even when a user of the terminal device who uses the sharing apparatus turns off the power to the terminal device to terminate the use of the terminal device, therefore, the sharing apparatus may be used by a user of the other terminal device. Consequently, the user of the terminal device that is networked to the sharing apparatus confirms situations where the other terminal device that is networked to the sharing apparatus is used, and turns off the power to the sharing apparatus when it is judged that no terminal device uses the sharing apparatus.

In the above-mentioned system, however, the user who finally uses the sharing apparatus may, in some cases, forget to turn off the power to the sharing apparatus.

Therefore, a method of automatically turning off the power to a sharing apparatus, which is provided with a storage section storing identification numbers (e.g., IP addresses) assigned to all terminal devices that are networked to the sharing apparatus, when the sharing apparatus attempts to access each of the terminal devices corresponding to the identification numbers stored in the storage section, to judge that the powers to all the terminal devices that are networked to the sharing apparatus are turned off is proposed in JP2000-172474, A.

In the above-mentioned prior art, however, the sharing apparatus must attempt to access all the terminal devices to which it is networked in order to judge whether or not the power to the sharing apparatus should be turned off (make automatic switching judgment).

In a business office with a lot of employees, for example, a plurality of sharing apparatuses (e.g., printers) that are accessible from terminal devices respectively assigned to the employees may, in some cases, be installed in order to improve work efficiency. In such a case, the sharing apparatus must attempt to also access the terminal device assigned to the employee who does not usually use the sharing apparatus out of the terminal devices to which it is networked in order to make the automatic switching judgment in the configuration of the prior art. As a result, even in a case where the powers to the terminal devices assigned to all the employees who usually use the sharing apparatus are turned off, the power to the sharing apparatus is not automatically turned off unless the power to the terminal device assigned to the employee who does not usually use the sharing apparatus is turned off, resulting in wasteful power consumption.

### SUMMARY OF THE INVENTION

The present invention has been made under such a background and has for its object to provide a sharing apparatus capable of restraining wasteful power consumption and an energy conservation controlling method therefor.

The present invention is directed to a sharing apparatus (1) that is networked to a plurality of terminal devices (3), characterized by comprising a storage section (172) for storing, when any of the plurality of terminal devices accesses the sharing apparatus, an identification number assigned to the terminal device that has made the access; judgment means (10, T4, T5) for transmitting a signal to all the terminal devices corresponding to the identification numbers stored in the storage section to judge whether or not the terminal devices are accessible to the sharing apparatus; and power state switching means (10, T7) for switching, when it is judged that none of the terminal devices corresponding to the identification numbers stored in the storage section are accessible to the sharing apparatus as a result of the judgment by the judgment means, the state of the power to the sharing apparatus to a power saving state.

Alphanumeric characters in parentheses indicate corresponding constituent elements, for example, in the embodiment, described later.

According to this configuration, it is possible to judge whether or not the state of the power to the sharing apparatus is switched to a power saving state by storing, out of the terminal devices that are networked to the sharing apparatus, the identification number assigned to the terminal device that has accessed the sharing apparatus in the storage section in the sharing apparatus, transmitting a signal only to the terminal devices corresponding to the identification numbers stored in the storage section (attempting to access the terminal devices), and judging whether or not the terminal devices are accessible to the sharing apparatus.

If all the powers to the terminal devices that have accessed the sharing apparatus are turned off, the power to the sharing apparatus is switched to a power saving state, unlike such a configuration that it is judged whether or not the state of the power to the sharing apparatus is switched by attempting to access all the terminal devices that are networked to the sharing apparatus.

This makes it possible to prevent situations where in a case where all the powers to terminal devices that usually use a sharing apparatus are turned off, the power to the sharing apparatus is not switched to a power saving state because the power to a terminal device that does not usually use the sharing apparatus is not turned off, thereby making it possible to restrain wasteful power consumption.

If the terminal device is set so as to be rejected from an object to which a signal is to be transmitted from the sharing apparatus (that the sharing apparatus attempts to access) in judging whether or not the power to the sharing apparatus is switched to a power saving state, judgment whether or not the power to the terminal device is turned off does not affect the results of the judgment even when the identification number is stored in the storage section in the sharing apparatus by accessing the sharing apparatus.

That is, even in a case where out of the terminal devices that have accessed the sharing apparatus, the terminal device that must be always operated without turning off the power thereto, for example, a file server, exists, if the terminal device is set so as to be rejected from an object of the judgment, the powers to all the terminal devices other than the terminal device rejected from the object of the judgment are turned off so that the state of the power to the sharing apparatus is switched to a power saving state, thereby making it possible to restrain wasteful power consumption.

If an energy conservation controlling method according to the present invention is used, when the sharing apparatus is substantially accessed, the sharing apparatus can be brought into a state where it consumes little or no power.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of an MFP serving as a sharing apparatus according to an embodiment of the present invention;

FIG. 2 is a flow chart showing the flow of control by a control section in a case where automatic switching setting is made; and

FIG. 3 is a flow chart showing the flow of control by a control section in a state where the power to an MFP is turned on.

### DETAILED DESCRIPTION OF THE PREFERRED EMBODIMENTS

Referring now to the drawings, an embodiment of the present invention will be specifically described.

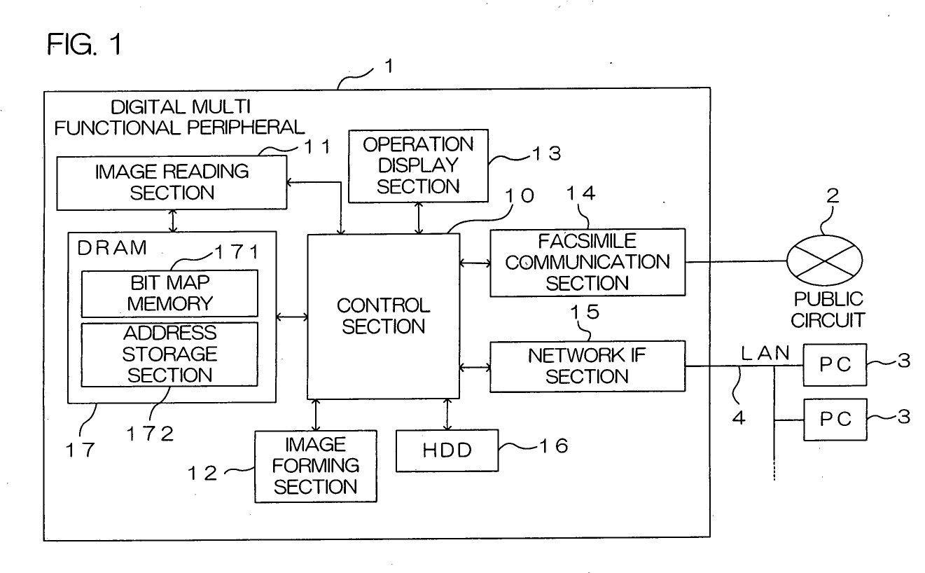

FIG. 1 is a block diagram showing the configuration of a digital MFP (Multi Function Peripheral) 1 serving as a sharing apparatus according to an embodiment of the present invention.

Referring to FIG. 1, the MFP 1 comprises a copying function capable of forming an image on paper on the basis of image data relating to a document read by an image reading section 11, a facsimile function capable of forming an image on paper on the basis of image data inputted by facsimile communication through a public circuit 2, and a printer function capable of forming an image on paper on the basis of image data inputted by network communication with a terminal device 3 (e.g., a PC (Personal Computer)) to which it is networked.

The MFP 1 comprises an image forming section 12 for forming an image on paper, an operation display section 13 for setting the contents of the operation of the MFP 1 and displaying the operating conditions and the set contents of the MFP 1, and soon in addition to the above-mentioned image reading section 11.

The image reading section 11 irradiates light toward a set document, for example, and outputs image data based on light reflected from the document. The configuration of the image forming section 12 is a well-known configuration including a photoreceptor, a main charger, a developing device, a transfer device, a fixing device, and so on, for example. That is, when an image is formed, a surface of the photoreceptor in an approximately cylindrical shape is uniformly charged by the main charger, and a laser beam is irradiated onto the surface of the photoreceptor on the basis of the image data so that a so-called electrostatic latent image is formed on the surface of the photoreceptor. Toner selectively adheres to the surface of the photoreceptor having the electrostatic latent image formed thereon by the developing device to form a toner image. After the toner image formed on the surface of the photoreceptor is transferred onto paper by the function of the transfer device, the paper after the transfer is subjected to predetermined fixing processing (e.g., heating processing and pressurization processing) by the fixing device, thereby achieving image formation on the paper.

The operation of the MFP 1 is controlled by a control section 10 including a microcomputer. A facsimile communication section 14, a network IF (Interface) section 15, an HDD (Hard Disk Drive) 16, a DRAM (Dynamic Random Access Memory) 17, and so on are connected to the control section 10 so as to be inputtable/outputtable in addition to the image reading section 11, the image forming section 12, and the operation display section 13, as mentioned above.

The facsimile communication section 14 is for connecting the MFP 1 to the public circuit 2 and transmitting and receiving a signal to and from (establishing facsimile communication with) another facsimile machine or MFP connected to the public circuit 2, for example. The network IF section 15 is for making it possible to network-connect the MFP 1 to the plurality of terminal devices 3 through a LAN (Local Area Network) 4 and transmit and receive a signal to and from (establish network communication with) the plurality of terminal devices 3 that are networked to the MFP 1.

The HDD 16 is a nonvolatile memory. Image data relating to the document read by the image reading section 11, image data inputted by the facsimile communication, and image data inputted by the network communication are respectively stored once in the HDD 16. The DRAM 17 is a volatile memory. The image data stored in the HDD 16 is expanded in a bit map memory 171 provided in the DRAM 17 so that an image is formed by the image forming section 12 on the basis of the expanded image data.

The DRAM 17 comprises an address storage section 172 for storing, when the terminal device 3 which is networked to the MFP 1 accesses the MFP 1 after the power to the MFP 1 is turned on, an identification number (e.g., an IP address (Inter Protocol Address)) assigned to the terminal device 3 that has made the access.

The present embodiment is characterized in that a signal is periodically transmitted from the MFP 1 to (the MFP 1 attempts to access) all the terminal devices 3 corresponding to the IP addresses stored in the address storage section 172 in order to judge whether or not the terminal devices 3 are accessible to the MFP 1 (make automatic switching judgment), and the state of the power to the MFP 1 is automatically switched to a power saving state when it is judged that all the terminal devices 3 corresponding to the IP addresses stored in the address storage section 172 are not accessible to the MFP 1 as a result of the judgment.

This configuration causes, if all the powers to the terminal devices 3 that have accessed the MFP 1 are turned off, the power to the MFP 1 is to be switched to a power saving state, unlike such a configuration that the MFP 1 attempts to access all the terminal devices 3 to which it is networked to judge whether or not the state of the power to the MFP 1 is switched.

This makes it possible to prevent situations where in a case where all the powers to the terminal devices 3 that usually use the MFP 1 are turned off, the power to the MFP 1 is not switched to a power saving state because the power to the terminal device 3 that does not usually use the MFP 1 is not turned off, thereby making it possible to restrain wasteful power consumption.

Out of the terminal devices 3 that are networked to the MFP 1, the terminal device 3 (e.g., a file server) that must be always operated without turning off the power thereto may, in some cases, exist.

In the present embodiment, therefore, the terminal device 3 that must be always operated without turning off the power thereto, for example, a file server can be set so as to be rejected from an object to which a signal is to be transmitted from the MFP 1 (that the MFP 1 attempts to access) in the case of the automatic switching judgment (subjected to automatic switching setting). Even when the terminal device 3 thus set accesses the MFP 1 so that the IP address is stored in the address storage section 172 in the MFP 1, judgment whether or not the power to the terminal device 3 is turned off does not affect the results of the automatic switching judgment.

That is, even in a case where out of the terminal devices 3 that have accessed the MFP 1, the terminal device 3 that must be always operated without turning off the power thereto, for example, a file server, exists, if the terminal device 3 is set so as to be rejected from an object of the automatic switching judgment, the powers to all the terminal devices 3 other than the terminal device 3 rejected from the object of the automatic switching judgment are turned off so that the state of the power to the MFP 1 is switched to a power saving state, thereby making it possible to restrain wasteful power consumption.

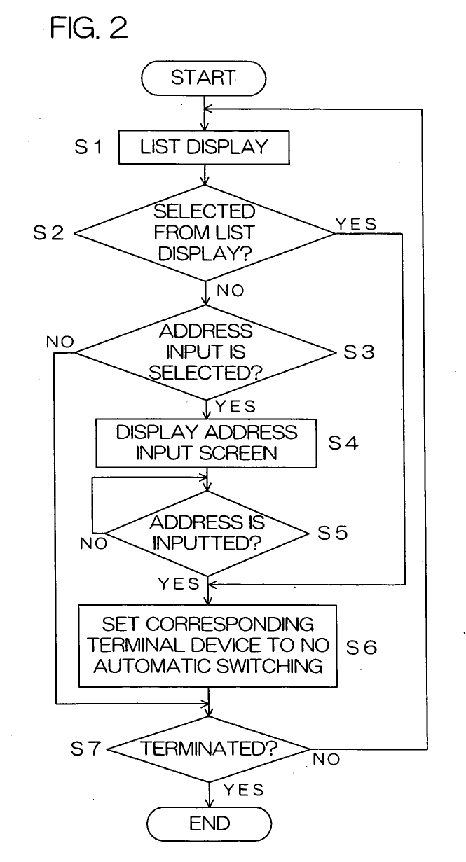

FIG. 2 is a flow chart showing the flow of control by the control section 10 in a case where the automatic switching setting is made.

Referring to FIG. 2, when it is determined that the automatic switching setting is performed by operating the operation display section 13, for example, the control section 10 first displays the IP addresses assigned to all the terminal devices 3 that are networked to the MFP 1 as a list on the operation display section 13. The IP address assigned to the terminal device 3 that is networked to the MFP 1 is previously inputted into the HDD 16 in the MFP 1.

Thereafter, when any of the IP addresses which are displayed as a list on the operation display section 13 is selected by operating the operation display section 13 (YES in step S2), the control section 10 make setting so as to reject the terminal device 3 corresponding to the selected IP address from the object of the automatic switching judgment (setting to no automatic switching) (step S6).

In the present embodiment, the terminal device 3 can be also specified by operating the operation display section 13 to input the IP address. When the input of the IP address is selected (No in step S2, YES in step S3), the control section 10 displays an address input screen for inputting the IP address on the operation display section 13 (step S4).

Thereafter, when the IP address is inputted on the address input screen (YES in step S5), the control section 10 makes setting so as to reject the terminal device 3 corresponding to the inputted IP address from the object of the automatic switching judgment (setting to no automatic switching) (step S6). Data representing the set contents of the automatic switching setting is stored in correspondence with data representing the IP address stored in the address storage section 172.

After the IP address is selected from the list display or the IP address is inputted on the address input screen in such a way, when an operation for terminating the automatic switching setting is performed by the operation display section 13 (YES in step S7), the control section 10 terminates the automatic switching setting.

In the automatic switching setting, the specific terminal device 3 may be settable to no automatic switching for each day of the week. In this case, it may be determined which day of the week should be set to no automatic switching by operating the operation display section 13, and the contents of the determination may be stored in a weekly timer (not shown) provided in the HDD 16. When the power to the MFP 1 is turned on, the control section 10 may read out the contents of the determination corresponding to the day of the week from the weekly timer and make setting so as to reject the terminal device 3, which is set to no automatic switching for the day of the week, from the object of the automatic switching judgment.

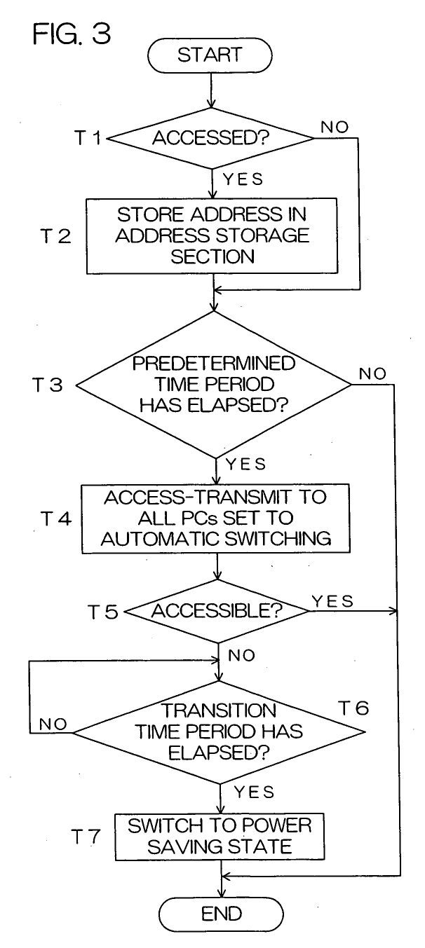

FIG. 3 is a flow chart showing the flow of control by the control section 10 in a state where the power to the MFP is turned on.

Referring to FIG. 3, the control section 10 monitors whether or not the terminal device 3 that is networked to the MFP 1 accesses the MFP 1 (a signal is transmitted from the terminal device 3 to the MFP 1) (step T1) in a state where the power to the MFP 1 is turned on, and a predetermined signal is transmitted (access-transmitted) to the terminal device 3 other than the terminal device 3 that is set as the object of the automatic switching judgment out of the IP addresses stored in the address storage section 172 (set to automatic switching), that is, the terminal device 3 that is set to no automatic switching by the automatic switching setting every time a predetermined time period has elapsed (YES in step T3) in order to judge whether or not the terminals 3 are accessible to the MFP 1 (automatic switching judgment; steps T4 and T5).

When the terminal device 3 that is networked to the MFP 1 accesses the MFP 1 (YES in step T1), the control section 10 stores the IP address assigned to the terminal device 3 that has made the access in the address storage section 172 (step T2).

In the automatic switching judgment (steps T4 and T5), in a case where out of the terminal devices 3 that have been access-transmitted, the terminal device that is accessible exists, a predetermined signal is returned from the terminal device 3. When there is no return from any of the terminal devices 3 within a predetermined time period, the control section 10 judges that the power to the terminal device 3 is turned off and deletes the IP address corresponding to the terminal device 3 from the address storage section 172. When the IP address corresponding to only the terminal device 3 that is set to no automatic switching by the automatic switching setting is stored in the address storage section 172, the control section 10 judges that there is no terminal device 3 that is accessible (No in step T5). Thereafter, after a predetermined transition time period has elapsed (YES in step T6), the state of the power to the MFP 1 is automatically switched to a power saving state (step T7).

The power saving state may be a state where power consumption is made lower than that in a normal stand-by state of the MFP 1. For example, the power saving state may be a state where supply power to the fixing device in the image forming section 12 is reduced so that the fixing device is maintained at a low temperature, a state where power supply to the fixing device is stopped so that image data can be only received by facsimile communication, a state where the power to the MFP 1 is completely turned off, and so on.

The present invention is not limited to the contents of the foregoing embodiment. Various changes are possible within the claims.

For example, the place where the IP address is stored is not limited to the DRAM 17. For example, the IP address may be stored in another memory provided in the digital MFP 1. In this case, the memory storing the IP address may be not only the DRAM 17 but also another volatile memory.

Although in the above-mentioned embodiment, description was made of such a configuration that the automatic switching setting is made by the MFP 1, the present invention is not limited to the same. For example, the automatic switching setting may be made by the terminal device 3. Although in the above-mentioned embodiment, description was made of such a configuration that the terminal device 3 corresponding to the IP address selected by the automatic switching setting is set to no automatic switching, the present invention is not limited to the same. For example, the terminal device 3 corresponding to the IP address selected by the automatic switching setting may be set to automatic switching (set to the object of the automatic switching judgment).

In a case where two MFPs 1 are connected by so-called tandem connection, when it is judged that there is no terminal device 3 that is accessible to both of the MFPs 1, the states of the powers to both of the MFPs 1 may be simultaneously switched to a power saving state.

The identification number assigned to the terminal device 3, which is stored in the MFP 1, is not limited to the IP address. For example, the identification number may be another identification number assigned to each of the terminal devices 3, for example, a serial number.

The sharing apparatus is not limited to the MFP 1. For example, the sharing apparatus may be an image forming apparatus, which is not in a complex form, such as a copying machine, a printer, or a facsimile. Alternatively, the sharing apparatus may be electrical equipment (e.g., a DVD recorder) other than the image forming apparatus.

The terminal device 3 is not limited to the personal computer. For example, the terminal device 3 may be another electrical equipment that is networked to the sharing apparatus.

Although the present invention has been described and illustrated in detail, it is clearly understood that the same is by way of illustration and example only and is not to be taken by way of limitation, the spirit and scope of the present invention being limited only by the terms of the appended claims.

This application corresponds to Japanese Patent Application No. 2004-113448 filed with the Japanese Patent Office on Apr. 7, 2004, the disclosure of which is incorporated herein by reference.

What is claimed is:

1. A sharing apparatus that is networked to a plurality of terminal devices, comprising:
a storage section for storing, when any of the plurality of terminal devices accesses the sharing apparatus, an identification number assigned to the terminal device that has made the access;
judgment means for transmitting a signal to all the terminal devices corresponding to the identification numbers stored in the storage section to judge whether or not the terminal devices are accessible to the sharing apparatus; and
power state switching means for switching, when it is judged that none of the terminal devices corresponding to the identification numbers stored in the storage section are accessible to the sharing apparatus as a result of the judgment by the judgment means, the state of the power to the sharing apparatus to a power saving state.

2. The sharing apparatus according to claim 1, further comprising
setting means for making setting so as to reject, out of the plurality of terminal devices, the predetermined terminal device from an object to which a signal is to be transmitted in the case of the judgment by the judgment means.

3. The sharing apparatus according to claim 2, wherein
the sharing apparatus comprises an MFP (Multi Function Peripheral).

4. The sharing apparatus according to claim 3, wherein
the power saving state includes a state where the MFP cannot form an image but can establish communication.

5. The sharing apparatus according to claim 2, wherein
the setting means can change the terminal device that is rejected for each day of the week or for each month.

6. The sharing apparatus according to claim 1, wherein
a state where the terminal device is accessible includes a state where the power to the terminal device is turned on.

7. The sharing apparatus according to claim 1, wherein
the power saving state includes a state where the power to the sharing apparatus is turned off.

8. An energy conservation controlling method for a sharing apparatus that is networked to a plurality of terminal devices, comprising the steps of:
storing an identification number assigned to the terminal device that has accessed the sharing apparatus;
judging whether or not the terminal device corresponding to the stored identification number is accessible to the sharing apparatus at predetermined timing; and
switching the state of the power to the sharing apparatus to a power saving state on the basis of the judgment that all the terminal devices corresponding to the stored identification numbers are inaccessible to the sharing apparatus.

9. The energy conservation controlling method according to claim 8, wherein
a state where the terminal device is inaccessible to the sharing apparatus includes a state where the power to the terminal device is turned off.

10. The energy conservation controlling method according to claim 8, wherein
the power saving state includes a state where only a predetermined function is executable and the other function is not executable.
